(19) United States
(12) Patent Application Publication
(10) Pub. No.: US 2019/0060885 A1
(43) Pub. Date: Feb. 28, 2019

(54) PARTICLE FILTER HAVING SCR-ACTIVE COATING

(71) Applicant: UMICORE AG & CO. KG, Hanau-Wolfgang (DE)

(72) Inventors: Frank WELSCH, Rodenbach (DE); Stephan ECKHOFF, Alzenau (DE); Michael SEYLER, Mainaschaff (DE); Anke SCHULER, Niedernberg (DE)

(73) Assignee: UMICORE AG & CO. KG, Hanau-Wolfgang (DE)

(21) Appl. No.: 16/086,757

(22) PCT Filed: Apr. 13, 2017
(86) PCT No.: PCT/EP2017/058901

§ 371 Date: Sep. 20, 2018

(30) Foreign Application Priority Data
Apr. 13, 2016 (EP) 16165079.1

(51) Int. Cl. B01J 29/76; B01D 53/94; B01J 29/072; B01J 29/80; B01J 35/00; B01J 37/02; F01N 3/08; F01N 3/20; F01N 3/28

(52) U.S. Cl. CPC B01J 29/763; B01D 2255/9032; B01D 53/9477; B01J 29/072; B01J 29/80; B01J 35/0006; B01J 37/0246; F01N 3/0842; F01N 3/2066; F01N 3/2803; B01D 2251/2062; B01D 2255/1021; B01D 2255/20738; B01D 2255/20761; B01D 2255/50; B01D 53/9418

(57) ABSTRACT

The invention relates to a particle filter, which comprises a wall flow filter and two SCR-catalytically active materials A and B which are different from each other, wherein the SCR-catalytically active material A contains a zeolite of the chabazite structure type, which contains ion-exchanged iron and/or copper, and the SCR-catalytically active material B contains a zeolite of the levyne structure type, which contains ion-exchanged iron and/or copper, wherein (i) the SCR-catalytically active materials A and B are in the form of two material zones A and B, wherein material zone A extends from the first end of the wall flow filter at least over part of the length L and material zone B extends from the second end of the wall flow filter at least over part of the length L, or wherein (ii) the wall flow filter is formed by the SCR-catalytically active material A or B and a matrix component and the SCR-catalytically active material B or A extends at least over part of the length L of the wall flow filter in the form of a material zone B or A.

The present invention relates to a particle filter with SCR-active coating for the simultaneous reduction of particles and nitrogen oxides in the exhaust gas of combustion engines.

Exhaust gases from motor vehicles with a predominantly lean-operated combustion engine contain, in particular, the primary emissions of carbon monoxide CO, hydrocarbons HC, and nitrogen oxides NOx in addition to particle emissions. Due to the relatively high oxygen content of up to 15 vol %, carbon monoxide and hydrocarbons can be made harmless relatively easily by oxidation. However, the reduction of nitrogen oxides into nitrogen turns out to be significantly more difficult.

A known method for removing nitrogen oxides from exhaust gases in the presence of oxygen is selective catalytic reduction (SCR method) by means of ammonia on a suitable catalyst. In this method, the nitrogen oxides to be removed from the exhaust gas are converted to nitrogen and water using ammonia. The ammonia used as reducing agent may be made available by feeding an ammonia precursor compound, for example urea, ammonium carbamate, or ammonium formate, into the exhaust gas stream, and by subsequent hydrolysis.

Particles may be very effectively removed from the exhaust gas with the aid of particle filters. Wall flow filters made from ceramic materials have especially proven themselves. These wall flow filters are made up of a plurality of parallel channels that are formed by porous walls. The channels are alternately sealed in a gas-tight manner at one of the two ends of the filter so that first channels are formed that are open at the first side of the filter and sealed at the second side of the filter and second channels are formed that are sealed at the first side of the filter and open at the second side of the filter. The exhaust gas flowing into the first channels, for example, may leave the filter again only via the second channels, and must flow through the porous walls between the first and second channels for this purpose. The particles are retained when the exhaust gas passes through the wall.

It is also already known to coat wall flow filters with SCR-active material and to thus simultaneously remove particles and nitrogen oxides from the exhaust gas. Such products are typically referred to as SDPF.

Insofar as the required quantity of SCR-active material is applied onto the porous walls between the channels (what is known as on-wall coating), this may however lead to an unacceptable increase in the back pressure of the filter. With this as the background, JPH01-151706 and WO2005/016497, for example, propose to coat a wall flow filter with an SCR catalyst such that the latter penetrates through the porous walls (what is known as in-wall coating).

It has also already been proposed—see U.S. 2011/27460:1.—to introduce a first SCR catalyst into the porous wall, i.e., to coat the inner surfaces of the pores, and place a second SCR catalyst onto the surface of the porous wall. In this case, the average particle size of the first SCR catalyst is smaller than that of the second SCR catalyst.

It has furthermore been proposed in WO2013/014467 A1 to arrange two or more SCR-active zones one after another on a particle filter. In this case, the zones may contain the same SCR-active material in different concentrations or different SCR-active materials. In each case, the more thermally stable SCR-active material is preferably arranged at the filter entrance.

Particle filters must be regenerated at defined time intervals, i.e., the accumulated soot particles must be burned off in order to keep the exhaust gas back pressure within an acceptable range. Exhaust gas temperatures of approximately 600° C. are required for filter regeneration and the initiation of the soot burn-off. In the burn-off, very high temperatures may occur that may be >800° C. It is known that higher temperatures may be reached in the region in which the exhaust gas exits from the filter than in the region in which the exhaust gas enters the filter. In the case of particle filters that are provided with SCR catalysts, the latter must withstand the high thermal stresses during filter regeneration without severe activity loss. However, there is still a significant need for improvement in this regard. Presently, SCR catalyst coatings that can withstand maximum temperatures of 800-850° C. are available on filters. However, in exceptional cases, temperature spikes of up to 1000° C. or more may be reached in the filter during soot regeneration if the soot burn-off proceeds in an uncontrolled manner, which may occur in certain driving situations of the vehicle.

Surprisingly, it has now been found that more temperature-stable diesel particle filters provided with an SCR function are obtained if different zeolite structure types, namely those of the chabazite (CHA) structure type and those of the levyne (LEV) structure type, are arranged in a specific manner on the diesel particle filter.

The present invention relates to a particle filter that comprises a wall flow filter and two SCR-catalytically active materials A and B that are different from each other, wherein the wall flow filter comprises channels of length L which extend in parallel between a first end and a second end of the wall flow filter, which are alternately sealed in a gas-tight manner either at the first end or at the second end and which are separated by porous walls; the SCR-catalytically active material A contains a zeolite of the chabazite structure type which contains ion-exchanged iron and/or copper and the SCR-catalytically active material B contains a zeolite of the levyne structure type which contains ion-exchanged iron and/or copper, wherein

(i) the SCR-catalytically active materials A and B are present in the form of two material zones A and B, wherein material zone A extends from the first end of the wall flow filter at least over a part of the length L and material zone B extends from the second end of the wall flow filter at least over a part of the length L, or wherein

(ii) the wall flow filter is formed from the SCR-catalytically active material A and a matrix component and the SCR-catalytically active material B extends in the form of a material zone B at least over a part of the length L of the wall flow filter, or wherein

(iii) the wall flow filter is formed from the SCR-catalytically active material B and a matrix component and the SCR-catalytically active material A extends in the form of a material zone A at least over a part of the length L of the wall flow filter.

In embodiments of the present invention, the zeolite of the chabazite structure type has a SAR value (ratio of silicon dioxide to aluminum oxide) of 6 to 40, preferably 12 to 40, and particularly preferably 25 to 40.

In embodiments of the present invention, the zeolite of the levyne structure type has a SAR value greater than 15, preferably greater than 30, for example from 30 to 50.

Zeolites of the chabazite structure type that are considered are, for example, the products known under the names chabazite and SSZ-13. Zeolites of the levyne structure type that are considered are, for example, Nu-3, ZK-20 and LZ-132. Within the scope of the present invention, coming under the term “zeolite” are not only aluminosilicates but also silicoaluminophosphates and aluminophosphates, which are occasionally also referred to as zeolite-like compounds. Examples are in particular SAPO-34 and AlPO-34 (CHA structure type) and SAPO-35 and AlPO-35 (LEV structure type).

In embodiments of the present invention, both the zeolite of the chabazite structure type and the zeolite of the levyne structure type contain ion-exchanged copper. Independently of one another, the copper quantities in the zeolite of the chabazite structure type and in the zeolite of the levyne structure type amount in particular to 0.2 to 6 wt %, preferably 1 to 5 wt %, calculated as CuO and in relation to the total weight of the exchanged zeolite. The atomic ratio of exchanged copper in the zeolite to lattice aluminum in the zeolite, referred to in the following as a Cu/Al ratio, is in particular 0.25 to 0.6 in the zeolite of the chabazite structure type and in the zeolite of the levyne structure type, independently of one another. This corresponds to a theoretical degree of exchange of the copper with the zeolite from 50% to 120%, assuming a complete charge balance in the zeolite via bivalent Cu ions given a degree of exchange of 100%. Cu/Al values of 0.35-0.5, which corresponds to a theoretical degree of Cu exchange of 70-100%, are particularly preferred.

Insofar as the zeolites that are used contain ion-exchanged iron, the iron quantities in the zeolite of the chabazite structure type and in the zeolite of the levyne structure type amount, independently of one another, in particular to 0.5 to 10 wt %, preferably 1 to 5 wt %, calculated as Fe₂O₃ and in relation to the total weight of the exchanged zeolite.

The atomic ratio of exchanged iron in the zeolite to lattice aluminum in the zeolite, referred to in the following as Fe/Al ratio, is in particular 0.25 to 3 in the zeolite of the chabazite structure type and in the zeolite of the levyne structure type, independently of one another. Fe/Al values from 0.4 to 1.5 are particularly preferred.

For example, aside from the zeolites of the chabazite structure type that are exchanged with copper or iron, material zone A comprises no catalytically active components. However, it may possibly contain additives, such as binders. For example, aluminum oxide, titanium oxide, and zirconium oxide are suitable binders, wherein aluminum oxide is preferred. In embodiments of the present invention, material zone A consists of copper-exchanged or iron-exchanged zeolites of the chabazite structure type, as well as of binder. Aluminum oxide is preferred as a binder.

For example, aside from the zeolites of the levyne structure type that are exchanged with copper or iron, material zone B also comprises no catalytically active components. However, it may possibly contain additives, such as binders. For example, aluminum oxide, titanium oxide, and zirconium oxide are suitable binders. In embodiments of the present invention, material zone A consists of copper-exchanged or iron-exchanged zeolites of the levyne structure type, as well as of binder. Aluminum oxide is preferred as a binder.

In embodiments of the present invention, 20 to 80 wt % of the catalytically active material, preferably 40 to 80 wt %, especially preferably 50 to 70 wt %, is in material zone B.

In a preferred embodiment of the particle filter according to the invention, the particle filter comprises a wall flow filter and SCR-catalytically active material, wherein the wall flow filter comprises channels of length L which extend in parallel between a first end and a second end of the wall flow filter, which are alternately sealed in a gas-tight manner either at the first or the second end, and which are separated by porous walls, wherein

the SCR-catalytically active material is present in the form of at least two material zones A and B that are different from one another, wherein

material zone A extends from the first end of the wall flow filter at least over a part of the length L and

material zone B extends from the second end of the wall flow filter at least over a part of the length L,

characterized in that

material zone A comprises a zeolite of the chabazite structure type which contains ion-exchanged iron and/or copper and

material zone B comprises a zeolite of the levyne structure type which contains ion-exchanged iron and/or copper.

In this embodiment, the exhaust gas preferably flows into the catalyst at the first end of the catalyst substrate and exits the catalyst at the second end of the catalyst substrate.

In this embodiment, the material zones A and B may furthermore be arranged on the particle filter in different ways.

In one embodiment of the particle filter according to the invention, material zone A, for example, extends over the entire length of the particle filter, whereas material zone B extends from the second end of the particle filter over 10 to 80% of the length L of the particle filter. In this case, material zone B is preferably arranged on material zone A.

In another embodiment of the particle filter according to the invention, material zone A extends from the first end of the particle filter over 20 to 90% of the length L of the particle filter, whereas material zone B extends from the second end of the particle filter over 10 to 70% of the length L of the particle filter. Insofar as material zones A and B overlap in this embodiment, material zone B is preferably arranged on material zone A.

In a further embodiment of the particle filter according to the invention, material zone A extends from the first end of the particle filter over 20 to 90% of the length L of the particle filter, whereas material zone B extends over the entire length L of the particle filter. In this case, material zone A is preferably arranged on material zone B.

Wall flow filters that may be used according to the present invention are known and commercially available. They consist, for example, of silicon carbide, aluminum titanate or cordierite.

In the uncoated state, they have porosities from 30 to 80, in particular 50 to 75%, for example. In the uncoated state, their average pore size is 5 to 30 micrometers, for example.

The pores of the wall flow filter are normally what are known as open pores, i.e., they have a connection to the channels that are formed by the porous walls of the wall flow filter. Furthermore, the pores are normally interconnected with one another. This enables easy coating of the inner pore surfaces on the one hand and an easy passage of the exhaust gas through the porous walls of the wall flow filter on the other hand.

The manufacturing of the particle filter according to the invention may take place according to methods familiar to the person skilled in the art, e.g., according to the typical dip coating method or pump and suction coating method with subsequent thermal post-treatment (calcination). It is known to the person skilled in the art that the average pore size of the wall flow filter and the average particle size of the SCR-catalytically active materials may be adapted to one another such that the material zones A and/or B are situated on the porous walls that form the channels of the wall flow filter (on-wall coating). However, average particle sizes of the SCR-catalytically active materials are preferably adapted to one another such that both material zone A and material zone B are located in the porous walls that form the channels of the wall flow filter, that a coating of the inner pore surfaces thus takes place (in-wall coating). In this instance, the average particle size of the SCR-catalytically active materials must be small enough to penetrate into the pores of the wall flow filter.

However, the present invention also encompasses embodiments in which one of the material zones A and B is coated in-wall and the other is coated on-wall.

The present invention also relates to embodiments in which the wall flow filter is formed from an inert matrix component and the SCR-catalytically active material A or B and the other SCR-catalytically active material, i.e., material B or A, extends in the form of a material zone B or A at least over a part of the length L of the wall flow filter. Wall flow filters that do not only consist of inert material, e.g., cordierite, but also additionally contain a catalytically active material are known to the person skilled in the art. For their production, a mixture of, for example, 10 to 95 wt % inert matrix component and 5 to 90 wt % catalytically active material is extruded according to methods known per se. All inert materials that are also otherwise used to manufacture wall flow filters may in this case be used as matrix components. These are, for example, silicates, oxides, nitrides, or carbides, wherein in particular magnesium aluminum silicates are preferred.

Like inert wall flow filters, the extruded wall flow filters that comprise the SCR-catalytically active material A or B may also be coated according to common methods. For example, a wall flow filter that comprises SCR-catalytically active material B may be coated over its entire length, or a part thereof, with a washcoat that contains the SCR-catalytically active material A.

For example, a wall flow filter that comprises SCR-catalytically active material A may likewise be coated over its entire length, or a part thereof, with a washcoat that contains the SCR-catalytically active material B.

The particle filters according to the invention having SCR-active coating may advantageously be used to purify exhaust gas of lean-operated combustion engines, in particular diesel engines. They are in this case to be arranged in the exhaust gas stream such that the SCR-catalytically active material A comes into contact with the exhaust gas to be purified before the SCR-catalytically active material B. Nitrogen oxides contained in the exhaust gas are thereby converted into the harmless compounds nitrogen and water.

The present invention accordingly also relates to a method for purifying exhaust gas of lean-operated combustion engines, characterized in that the exhaust gas is directed across a particle filter according to the invention, wherein the SCR-catalytically active material A comes into contact with the exhaust gas to be purified before the SCR-catalytically active material B.

In the method according to the invention, ammonia is preferably used as a reducing agent. For example, the required ammonia may be formed in the exhaust gas system upstream of the particle filter according to the invention, e.g., by means of an upstream nitrogen oxide storage catalyst (“lean NOx trap”—LNT). This method is known as “passive SCR.” However, ammonia may also be carried along in the form of aqueous urea solution that is dosed in as needed via an injector upstream of the particle filter according to the invention.

The present invention thus also relates to a system for purifying exhaust gas of lean-operated combustion engines, characterized in that it comprises a particle filter according to the invention having an SCR-active coating as well as an injector for aqueous urea solution, wherein the injector is located before the first end of the wall flow filter.

It is, for example, known from SAE-2001-01-3625 that the SCR reaction with ammonia proceeds more quickly if the nitrogen oxides are present in a 1:1 mixture of nitrogen monoxide and nitrogen dioxide, or in any event approach this ratio. Since the exhaust gas of lean-operated combustion engines normally has an excess of nitrogen monoxide compared to nitrogen dioxide, the document proposes to increase the proportion of nitrogen dioxide with the aid of an oxidation catalyst that is arranged upstream of the SCR catalyst.

In one embodiment of the system according to the invention for purifying exhaust gas of lean-operated combustion engines, it thus comprises, in the flow direction of the exhaust gas, an oxidation catalyst, an injector for aqueous urea solution, and a particle filter according to the invention with SCR-active coating, wherein the injector is located before the first end of the wall flow filter.

In embodiments of the present invention, platinum on a carrier material is used as an oxidation catalyst.

All materials that are familiar to the person skilled in the art for this purpose are considered as carrier materials. They have a BET surface of 30 to 250 m²/g, preferably of 100 to 200 m²/g (specified according to DIN 66132), and are in particular aluminum oxide, silicon oxide, magnesium oxide, titanium oxide, zirconium oxide, cerium oxide, and mixtures or mixed oxides of at least two of these oxides. Aluminum oxide and aluminum/silicon mixed oxides are preferred. If aluminum oxide is used, it is particularly preferable that it be stabilized such as with lanthanum oxide.

### EXAMPLE 1

a) A conventional wall flow filter made of cordierite was coated by means of a conventional dip method with a washcoat on 50% of its length starting from one end, which washcoat contained an aluminosilicate zeolite of the chabazite structure type exchanged with 4.0 wt % Cu. The SAR value of the zeolite was 30. The filter was then dried at 120° C.

b) In a second step, the wall flow filter obtained in step a) was likewise coated by means of a conventional dip method with a washcoat on 50% of its length starting from its other end, which washcoat contained an aluminosilicate zeolite of the levyne structure type exchanged with 3.5 wt % Cu. The SAR value of the zeolite was 31. It was then dried and calcined at 500° C. for 2 hours.

c) In a dynamic SCR test in a model gas system, wherein the model gas first comes into contact with the Cu chabazite and then with the Cu levyne, the wall flow filter so obtained shows a very good NOx conversion, namely in a range from 250 to above 550° C.

1. Particle filter that comprises a wall flow filter and two SCR-catalytically active materials A and B which are different from each other,
wherein the wall flow filter comprises channels of length L which extend in parallel between a first end and a second end of the wall flow filter, which are alternately sealed in a gas-tight manner either at the first end or at the second end and which are separated by porous walls; the SCR-catalytically active material A contains a zeolite of the chabazite structure type which contains ion-exchanged iron and/or copper and the SCR-catalytically active material B contains a zeolite of the levyne structure type which contains ion-exchanged iron and/or copper, wherein
(i) the SCR-catalytically active materials A and B are present in the form of two material zones A and B, wherein material zone A extends from the first end of the wall flow filter at least over a part of the length L and material zone B extends from the second end of the wall flow filter at least over a part of the length L, or wherein
(ii) the wall flow filter is formed from the SCR-catalytically active material A and a matrix component and the SCR-catalytically active material B extends in the form of a material zone B at least over a part of the length L of the wall flow filter, or wherein
(iii) the wall flow filter is formed from the SCR-catalytically active material B and a matrix component and the SCR-catalytically active material A extends in the form of a material zone A at least over a part of the length L of the wall flow filter.

2. Particle filter according to claim 1, characterized in that the zeolite of the chabazite structure type has a SAR value of 6 to 40.

3. Particle filter according to claim 1, characterized in that the zeolite of the levyne structure type has a SAR value of greater than 15.

4. Particle filter according to claim 1, characterized in that both the zeolite of the chabazite structure type and the zeolite of the levyne structure type contain ion-exchanged copper.

5. Particle filter according to claim 4, characterized in that the copper in the zeolite of the chabazite structure type and in the zeolite of the levyne structure type is, independently of one another, respectively present in quantities of 0.2 to 6 wt %, calculated as CuO and in relation to the total weight of the exchanged zeolites.

6. Particle filter according to claim 1, characterized in that the atomic ratio of copper to aluminum in the zeolite of the chabazite structure type and in the zeolite of the levyne structure type is, independently of one another, 0.25 to 0.6.

7. Particle filter according to claim 1, characterized in that 20 to 80 wt % of the catalytically active material is in material zone B.

8. Particle filter according to claim 1, characterized in that material zone A extends over the entire length of the particle filter and material zone B extends from the second end of the particle filter over 10 to 80% of the length L of the particle filter.

9. Particle filter according to claim 1, characterized in that material zone A extends from the first end of the particle filter over 20 to 90% of the length L of the particle filter, and material zone B extends from the second end of the particle filter over 10 to 70% of the length L of the particle filter.

10. Particle filter according to claim 1, characterized in that material zone A extends from the first end of the particle filter over 20 to 90% of the length L of the particle filter and material zone B extends over the entire length L of the particle filter.

11. Method for purifying exhaust gas of lean-operated combustion engines, characterized in that the exhaust gas is directed across a particle filter according to claim 1, wherein the SCR-catalytically active material A comes into contact with the exhaust gas to be purified before the SCR-catalytically active material B.

12. System for purifying exhaust gas of lean-operated combustion engines, characterized in that it comprises a particle filter according to to claim 1 as well as an injector for aqueous urea solution, wherein the injector is located before the first end of the wall flow filter.

13. System for purifying exhaust gas of lean-operated combustion engines comprising: in the flow direction of the exhaust gas, an oxidation catalyst, an injector for aqueous urea solution, and a particle filter according to claim 1, wherein the injector is located before the first end of the wall flow filter.

14. System according to claim 13, characterized in that platinum on a carrier material is used as an oxidation catalyst.
